(19) United States
(12) Patent Application Publication
(10) Pub. No.: US 2003/0001366 A1
(43) Pub. Date: Jan. 2, 2003

(54) Assembly consisting of a car body, a windshield, a dashboard and an airbag module

(75) Inventors: Jens Debler, Herlikofen (DE); Dirk Schultz, Schwabisch Gmund (DE); Joachim Lutz, Schechingen (DE)

Correspondence Address: TAROLLI, SUNDHEIM, COVELL,, TUMMINO & SZABO L.L.P., 1111 LEADER BLDG., 526 SUPERIOR AVENUE, CLEVELAND, OH, 44114-1400, US

(73) Assignee: TRW Occupant Restraint Systems GmbH & Co. KG

(21) Appl. No.: 10/173,758

(22) Filed: Jun. 18, 2002

(30) Foreign Application Priority Data
Jun. 28, 2001 (DE) 101 31 120.6

(51) Int. Cl. B60R 21/16

(52) U.S. Cl. 280/732

(57) ABSTRACT

An assembly consists of a car body, a windshield, a dashboard with an air vent for providing an air flow to the windshield, and an airbag module. The airbag module is arranged between the windshield and the air vent.

### TECHNICAL FIELD

The invention relates to an assembly consisting of a car body, a windshield, a dashboard with an air vent for providing an air flow to the windshield, and an airbag module.

### BACKGROUND OF THE INVENTION

Airbags are supposed to protect a vehicle occupant against violent contact with the vehicle structure by absorbing his/her kinetic energy and essentially decelerating the person's head. This requirement is especially difficult to meet if the vehicle occupant is not seated in an optimal position, i.e. when the upper trunk is leaning forwards or sideways. In such cases, the airbag has to unfold as far from the vehicle occupant as possible and over a wide area in order to be able to intercept the vehicle occupant in various positions. In the state of the art, this is achieved by an elongated airbag module that extends parallel to the front edge of the dashboard as is described, for example, in DE 23 38 025. In addition, however, it must also be possible to rule out any harn to the vehicle occupant as a result of the opening mechanism of the airbag module, for example, opening flaps or rupturing covers.

Therefore, the object of the invention is to provide an assembly of the above-mentioned type in which the airbag module is situated outside of the scope of action of the vehicle occupant.

### BRIEF SUMMARY OF THE INVENTION

According to the invention, an assembly is provided which consists of a car body, a windshield, a dashboard with an air vent for providing an air flow to the windshield, and an airbag module. The airbag module is arranged between the windshield and the air vent. This results in the maximum possible distance between the airbag module and the vehicle occupant, even if he/she is not seated in an optimal position. Thus, the opening mechanism of the airbag module, e.g. a covering flap that has to be torn open, can be situated outside of the scope of action of the vehicle occupant. Moreover, the arrangement of the airbag module in the rear area of the dashboard, relative to the vehicle occupant, allows a greater design freedom for the front area of the dashboard that is facing the vehicle occupant. Consequently, this area, which is critical for the vehicle interior design, can be coordinated with the overall vehicle concept without having to take functional requirements into account.

According to a preferred embodiment of the invention, it is provided that the airbag module has an airbag that is folded into an airbag package, that there is an ejection channel for the ejection of the airbag, this channel opening up into an ejection opening through which the airbag can be ejected, and that the airbag module has a housing, the ejection channel being limited by a first ejection channel wall that is formed by the housing and by a second ejection channel wall that is formed by the car body. Therefore, the housing only has to have one ejection channel wall, so that it can be greatly simplified, which leads to substantial savings of weight and material.

Additional advantageous embodiments of the invention will be apparent from the subordinate claims.

### BRIEF DESCRIPTION OF THE DRAWINGS

FIG. 1 shows a cross-section through an assembly according to a first embodiment of the invention;

FIG. 2 is an enlarged representation of area II from FIG. 1;

FIG. 3 is a partially cut-away view of a first embodiment of an airbag module for an assembly according to the invention;

FIGS. 3a to 3e show details of the gas bag module according to FIG. 3;

FIG. 4 is a partially cut-away view of a second embodiment of an airbag module for an assembly according to the invention;

FIG. 5 shows a cross-section through an assembly according to a second embodiment of the invention;

FIG. 6 is a view of the windshield holder, airbag module and air vent for an assembly according to a third embodiment of the invention;

FIG. 7 is a view of the windshield holder, windshield, airbag module and air vent for an assembly according to a fourth embodiment of the invention from a first perspective;

FIG. 8 is a view of the components of FIG. 7 from a second perspective;

FIG. 9 is a view of the airbag module of FIG. 7 from a third perspective;

FIG. 10 is a schematic view of the assembly of FIG. 1;

FIG. 11 shows a cross-section through an assembly according to a fifth embodiment of the invention;

FIG. 12 shows a cross-section through an assembly according to a sixth embodiment of the invention;

FIG. 13 shows a cross-section through a first embodiment of a gas lance of an airbag module for an assembly according to the invention;

FIG. 14 shows a cross-section through a second embodiment of a gas lance of an airbag module for an assembly according to the invention;

FIG. 15 shows a cross-section through a third embodiment of a gas lance of an airbag module for an assembly according to the invention;

FIG. 16 shows a cross-section through an assembly according to a seventh embodiment of the invention;

FIG. 17 shows a cross-section through an assembly according to an eighth embodiment of the invention;

FIG. 18 shows a cross-section through an assembly according to a ninth embodiment of the invention;

FIG. 19 shows a cross-section through an assembly according to a tenth embodiment of the invention;

FIG. 20 shows a cross-section through an assembly according to an eleventh embodiment of the invention;

FIG. 21 shows a cross-section through an assembly according to a twelfth embodiment of the invention;

FIG. 22 shows in a schematic, perspective view an assembly according to a thirteenth embodiment of the invention;

FIG. 23 shows in a partial sectional view in detail a type of mounting of a gas generator, as can be employed in the embodiment according to FIG. 4;

FIG. 24 shows in a sectional view the T-piece that is used in FIG. 23 for mounting the gas generator;

FIG. 25 is a further sectional view of the T-piece;

FIG. 26 is a top view of the T-piece;

FIG. 27 shows in a sectional view the type of mounting of FIG. 23;

FIG. 28 shows the gas generator of FIG. 27 in a section taken along plane A-A of FIG. 27;

FIG. 29 shows in a partially cut-away view a further type of mounting of a gas generator;

FIG. 30 shows in a schematic sectional view the type of mounting of FIG. 29;

FIG. 31 shows the gas generator of FIG. 30 in a section taken along plane A-A of FIG. 30;

FIG. 32 shows in a sectional view a further type of mounting of a gas generator; and

FIG. 33 shows in a partially cut-away view an assembly according to a fourteenth embodiment of the invention.

### DETAILED DESCRIPTION OF THE PREFERRED EMBODIMENTS

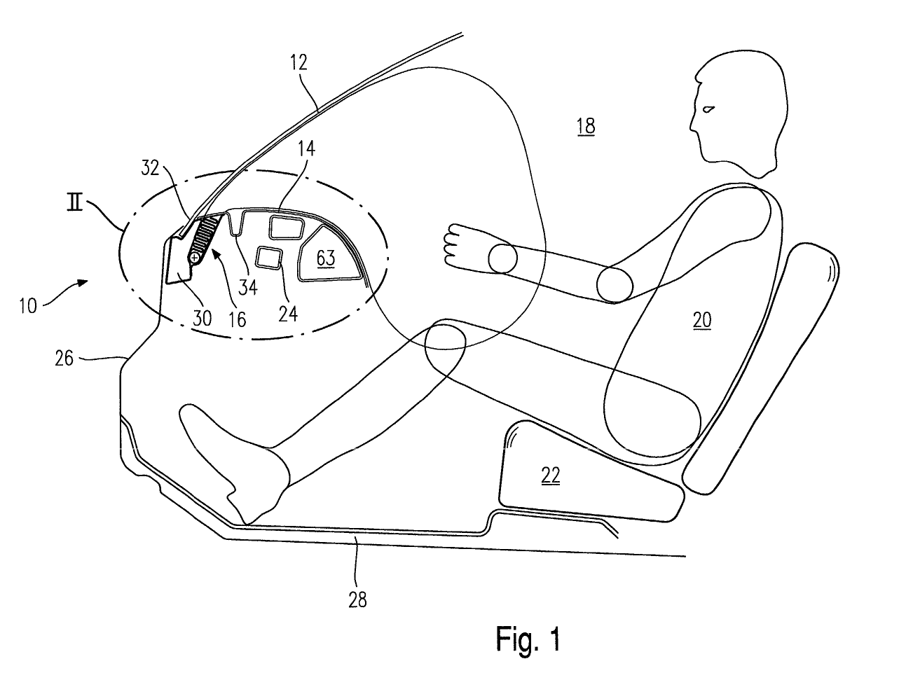

FIG. 1 schematically shows a cross-section of an assembly that consists of a car body 10, a windshield 12, a dashboard 14 and an airbag module 16. The car body 10 surrounds a vehicle interior 18 in which a vehicle occupant 20, who is schematically indicated in FIG. 1, can be present, for example, sitting on a seat 22. The car body 10 has frame parts 24, a splashboard 26 and a vehicle bottom 28. The car body 10 has a windshield holder 30 that supports the lower edge 32 of the windshield 12. The dashboard 14 extends from the windshield holder 30 into the vehicle interior 18, as a result of which it conceals the windshield holder 30 and the vehicle interior 24 from the view of the vehicle occupant 20. In the dashboard 14, there is an air vent 34 by means of which warm air can be conducted to the windshield 12 in order to prevent icing or condensation on the windshield.

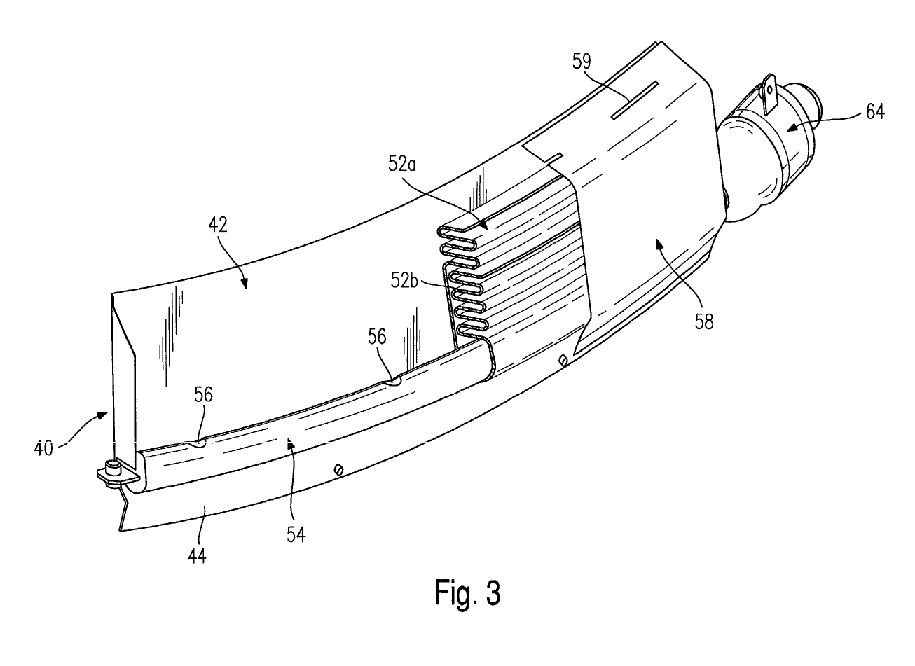

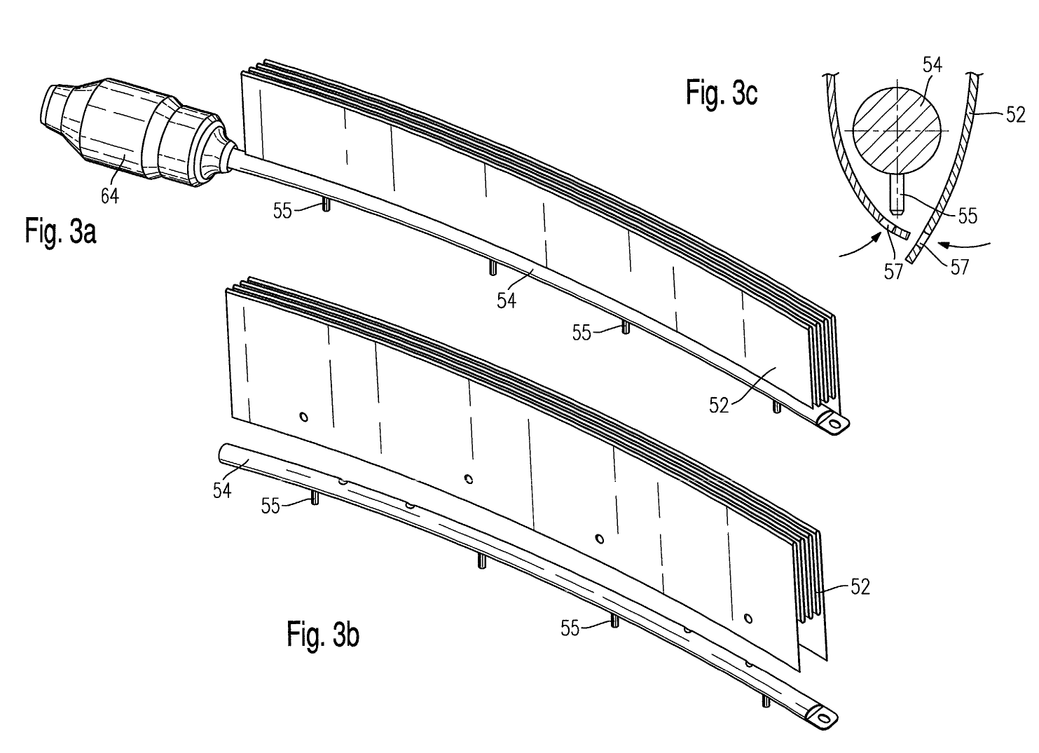

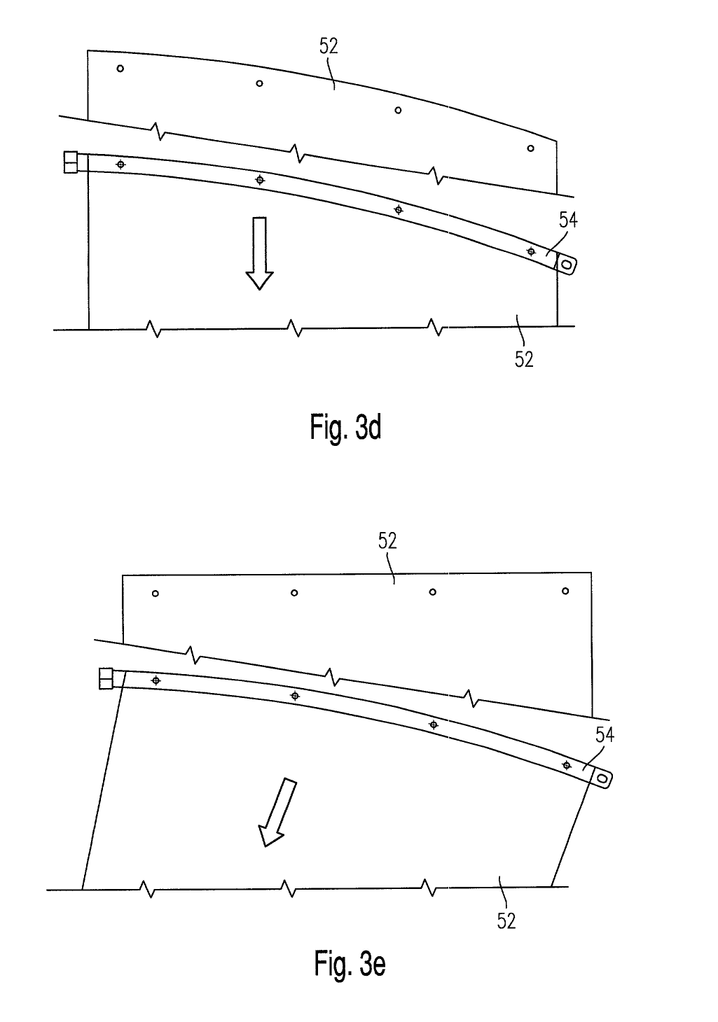

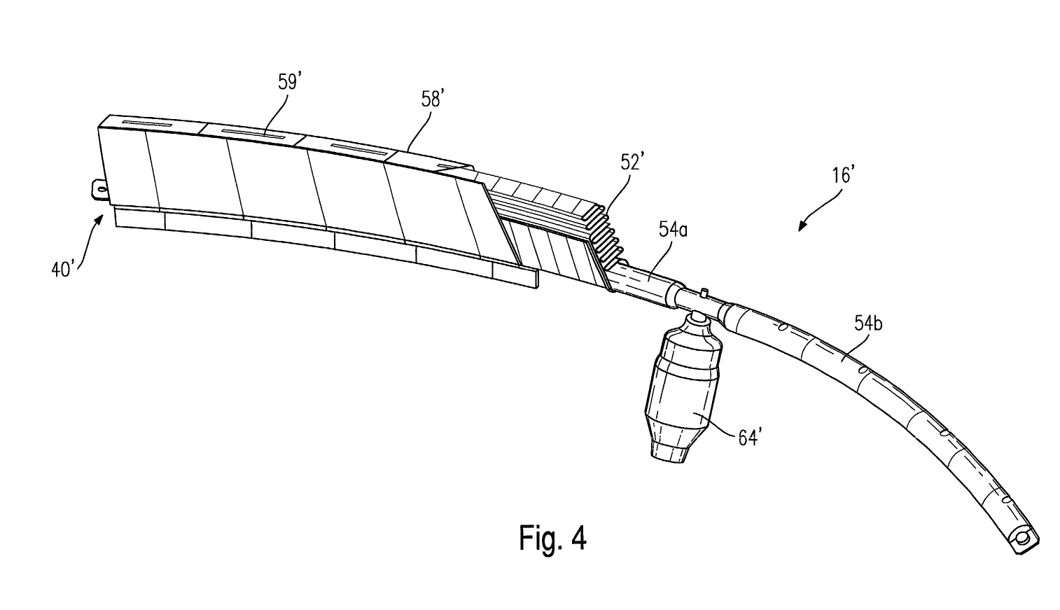

As shown in the Figures, the windshield holder 30 can be configured, for example, as a hollow profile made of plastic or metal. On its side facing away from the vehicle interior 18, there is an indentation 36 to accommodate the lower edge 32 of the windshield 12. The airbag module 16—two different embodiments of which are shown in more detail in FIGS. 3 and 4—is installed on the inner side 38 of the windshield holder 30 so as to face the vehicle interior 18.

In FIGS. 3a to 3e there are shown details of the gas bag module according to

FIG. 3. The gas lance 54 is provided with protrusions 55 which project from the gas lance in downward direction. Openings 57 which are provided on the lower end of the gas bag (see in particular FIG. 3c) can be hung in the protrusions. The protective layer 58 may also be hung in the protrusions 55. The protrusions 55 may be configured in one piece with the gas lance or welded to it.

By means of the FIGS. 3d and 3e, there will be briefly described how the mounting of the gas bag 52 on the gas lance has influence on the deployment direction. If the edge of the gas bag 52 extends corresponding to the geometry of the gas lance 54, as is shown in FIG. 3d, the gas bag will unfold vertically from top to bottom in the direction of the arrow. If, however, a gas bag with edges extending at right angles, as is shown in FIG. 3e, is hung in a curved gas lance extending obliquely, this will result in an unfolding direction obliquely downwards, as indicated by the arrow.

The airbag module 16 has a housing 40 whose cross-section consists of an essentially straight first ejection channel wall 42 and an adjacent angled attachment section 44. This attachment section 44 attaches the housing 40 to the windshield holder 30 in such a way that the first ejection channel wall 42 is orientated upwards, that is to say, towards the dashboard 14. Thus, the inside 38 of the windshield holder 30 forms a second ejection channel wall 46, as a result of which the two ejection channel walls 42 and 46 delimit an ejection channel 48 whose ejection opening 50 faces the dashboard 14. The ejection channel 48 accommodates an airbag 52 and a gas lance 54 that is inserted into the airbag, said gas lance 54 being provided with outflow openings 56 and being attached to the housing 40 adjacent to the attachment section 44 (FIG. 3). The airbag 52 is folded into a package that can consist of several partial packages 52a and 52b that are folded in different ways. For purposes of simpler assembly and in order to protect the airbag 52, the folded package can be covered with a protective layer 58, for example, in the form of a film or a fabric layer, that extends between the edges of the housing 40 and that can be provided with a perforation 59 in order to facilitate tearing open the protective layer 58.

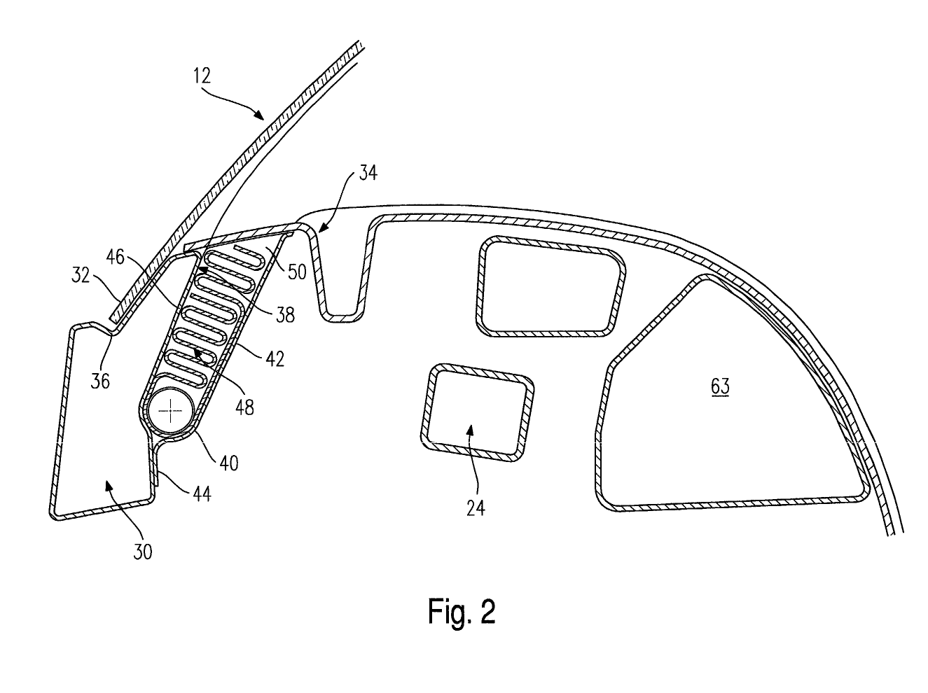

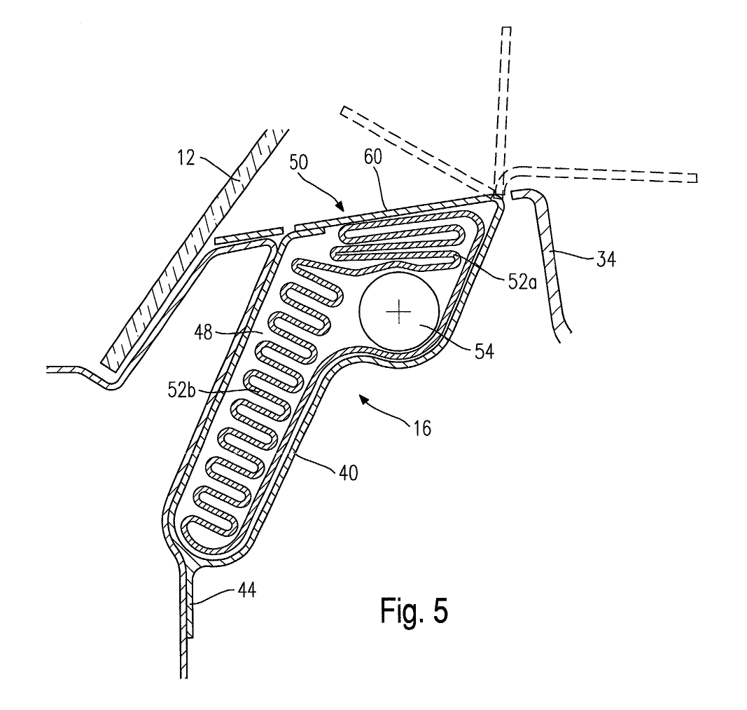

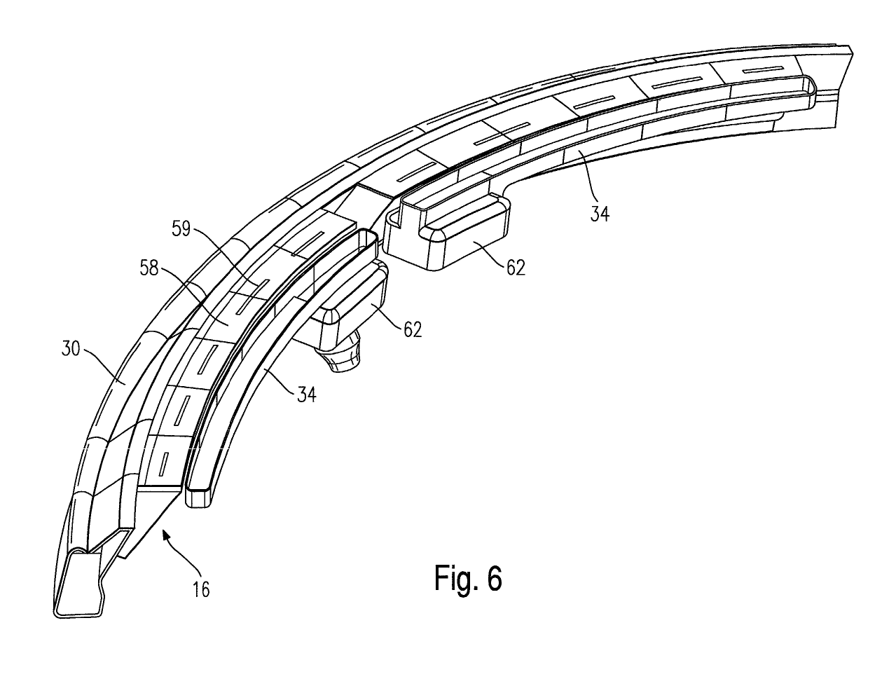

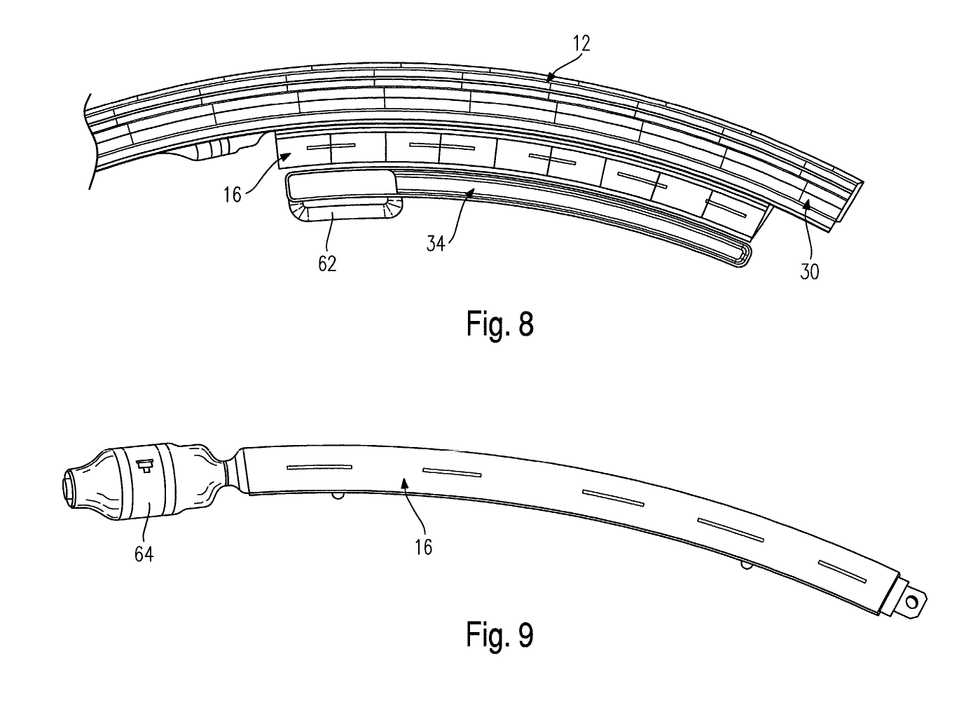

In the area of the airbag module 16, the dashboard 14 forms a cover 60 for the ejection opening 50 of the ejection channel 48 towards the windshield 12. In the known manner, the cover 60 can have a predetermined breaking point or tearing line which, in case of deployment, allows the cover 60 to be torn open and the airbag 52 to be deployed out of the ejection channel 48. As an alternative, the cover 60 can also be integrated in the housing 40 of the airbag module 16, as shown in FIG. 5, or in the air vent 34. In the direction towards the vehicle occupant 20, the airbag module 16 is followed by the air vent 34. As shown in FIGS. 1 and 2, this air vent 34 can either be integrated in the dashboard 14 or configured as a separate part. The second alternative is shown by way of an example in FIGS. 6 through 9, where the air vent 34 is provided in the form of one or two elongated ducts, for example, made of plastic. The ducts each open up at one end into a connection piece 62 that can be slipped onto a feed channel of the ventilation system. The ducts can be covered by the dashboard 14, which can, for example, have air outlet slits in this area.

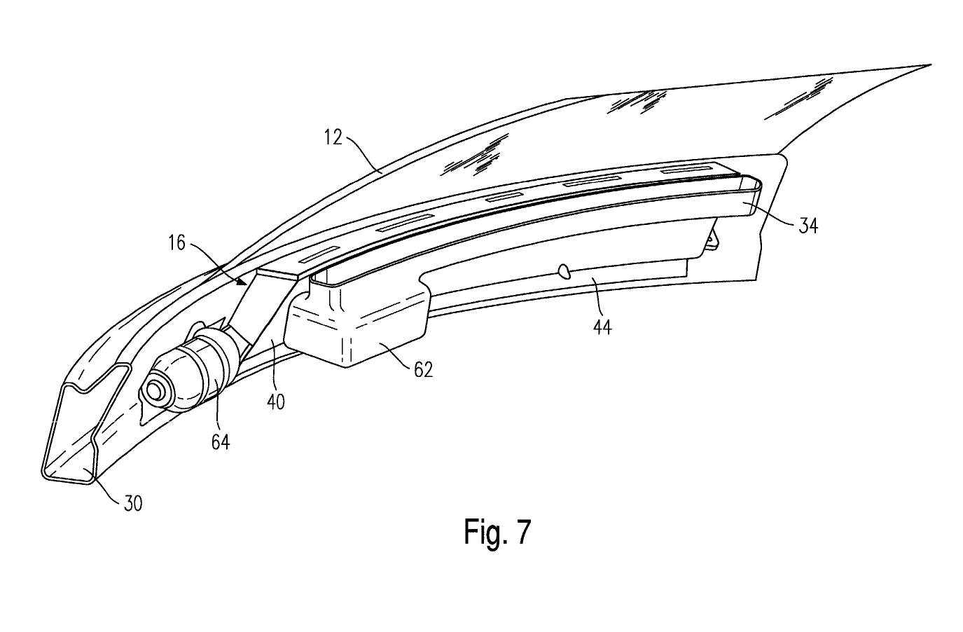

As can be clearly seen in FIG. 1, the movable parts of the opening mechanism of the airbag module 16, that is to say, the cover 60 that tears open, are far away from the interaction area of the vehicle occupant 20, even if he/she leans over forward, for instance, to reach into the glove compartment 63. Due to the elongated and narrow construction of the airbag module 16 (FIGS. 6 and 7), the air vent 34 can nevertheless be situated close enough to the windshield 12 to fulfill its function.

Advantageously, the airbag module 16 is curved so as to correspond to the shape of the car body 10, as can be seen in the embodiments of FIGS. 3, 4 and 6 through 9. The curvature can be adapted especially to the contour of the lower edge 32 of the windshield 12 so that the airbag module 16 can run as close as possible along the windshield 12 or to the windshield holder 30. Moreover, through the curvature, the airbag module 16 can advantageously be adapted to the design of the dashboard 14.

The gas lance 54 is connected to a gas generator 64 (FIG. 3) by means of which it can be supplied with compressed gas in order to inflate the airbag 52. In another embodiment of an airbag module 16′(FIG. 4), separate airbags 52′ and gas lances 54a and 54b are provided for the driver and for the passenger, both of which are connected to the same gas generator 64′.

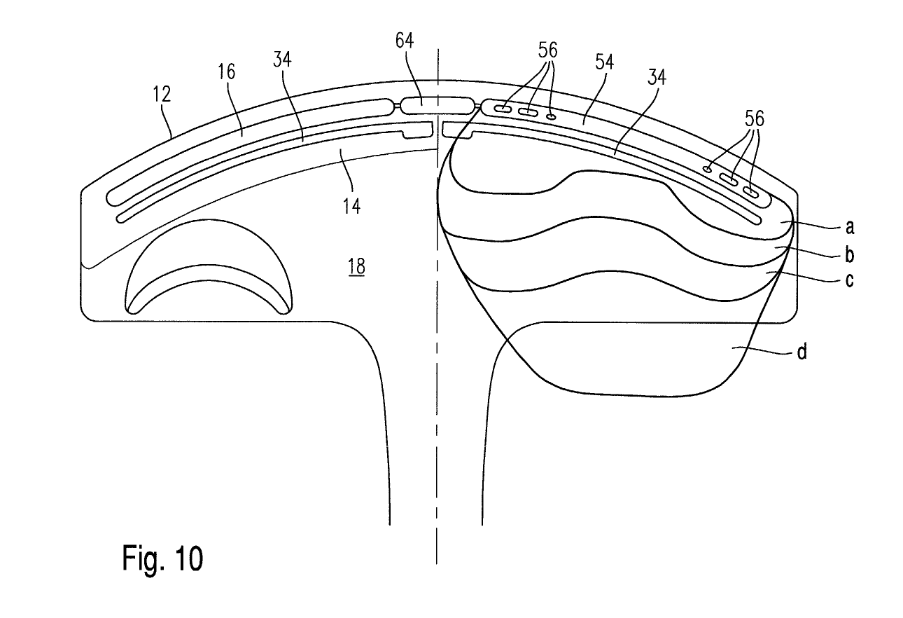

The specific propagation of the airbag 52 can also be influenced by the shape and arrangement of the outflow openings 56 in the gas lance 54, as shown in FIGS. 10 and 13 through 15. For one thing, by the arrangement of the outflow openings 56 at the ends of the gas lance 54, or in that the cross-sections of the outflow openings 56 in these areas are configured larger than in the middle, it can be achieved that the airbag 52 propagates more rapidly in the side areas. This is indicated in FIG. 10 by the various propagation phases a to d of the airbag 52. Such a propagation of the airbag 52 is especially advantageous whenever the vehicle occupant 20 is not seated in an optimal position.

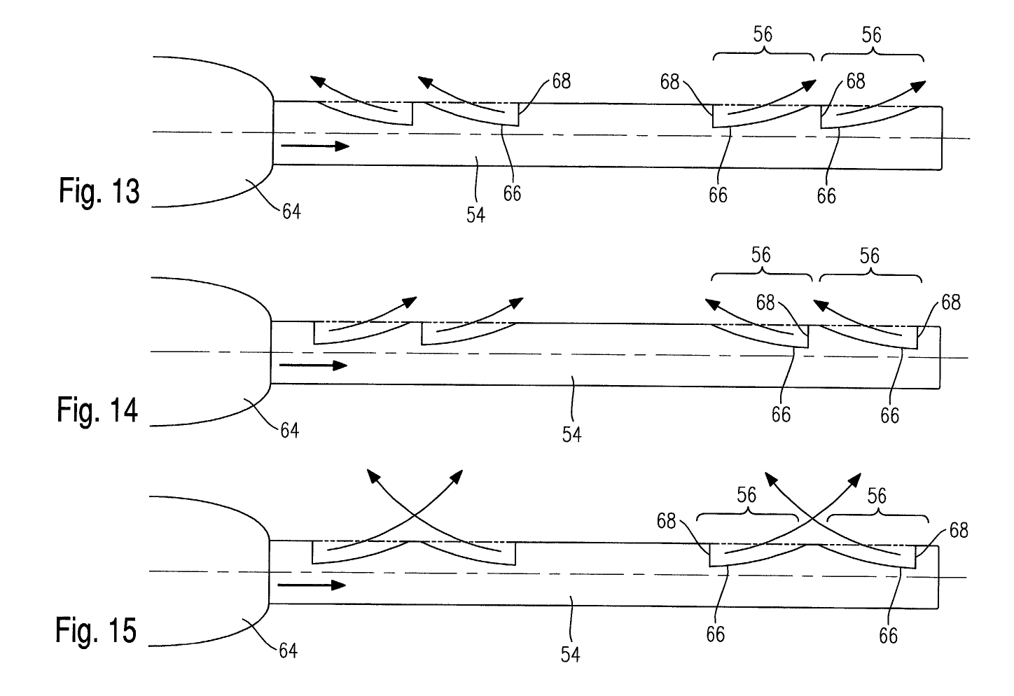

Secondly, the outflow openings 56 in the gas lance 54 can advantageously be configured in the form of gill-shaped indentations 66. FIGS. 13 through 15 show such outflow openings 56. They consist of indentations 66 pressed into the gas lance, one end of such indentation facing the lengthwise direction and being stamped, thus forming an opening 68 towards the inside of the tube. The outflow direction of the gas from the gas lance 54 is essentially predetermined by the gillshaped indentations 66, as is indicated by the arrows in FIGS. 13 through 15. In this manner, the escaping gas can be directed toward the ends (FIG. 13) or toward the middle (FIG. 14) of the gas lance 54 or else it can be swirled at the outflow openings 56 (FIG. 15).

All of the embodiments described so far lead to a wide propagation face of the airbag 52 right from the start. In conjunction with the maximum distance to the vehicle occupant, this means that the energy of the airbag 52 is reduced during the unfolding, especially in the central area of the airbag 52, consequently reducing the load on a vehicle occupant 20 who is not seated in an optimal position.

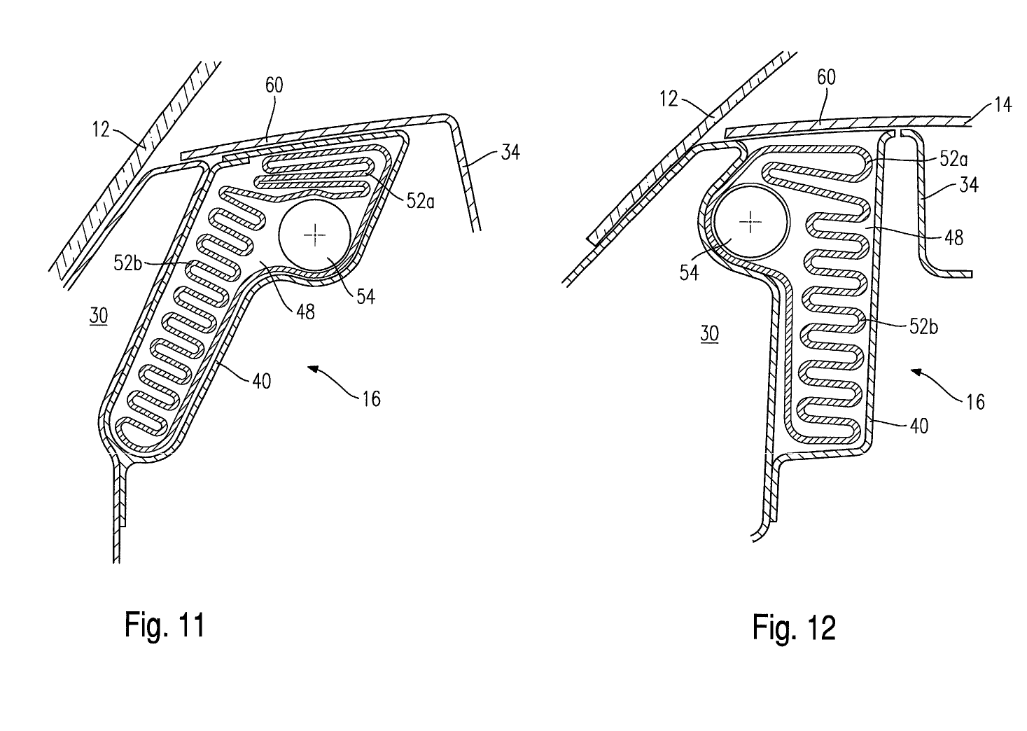

Another possibility of controlling the unfolding of the airbag lies in the arrangement of the gas lance 54 in the airbag module 16, as shown by way of examples in FIGS. 11 and 12.

In FIG. 11, the gas lance 54 is not arranged below the entire airbag package 52 but rather is covered by the upper partial package 52a, which comprises just a few layers, and is next to the partial package 52b, namely, on the side facing the vehicle interior 18. Thanks to this arrangement, when the airbag module 16 is deployed, first the few layers of the upper partial package 52a are ejected in the direction of the windshield 12 and then the remaining layers of the lower partial package 52b are pulled out by the unfolding airbag 52, whereby the airbag 52 can unfold in an advantageous manner along the windshield 12.

In FIG. 12, the gas lance is similarly situated, except that it is on the side of the folded lower partial package 52b facing the outside of the vehicle, so that, in contrast to the embodiment according to FIG. 11, the airbag 52 is unfolded more along the dashboard 14.

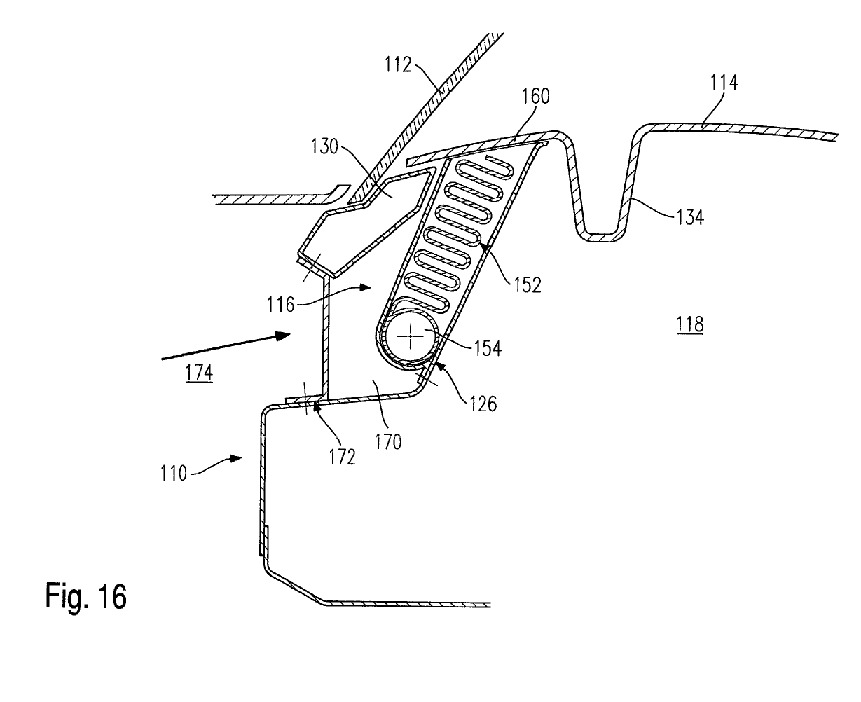

Another embodiment of an assembly according to the invention is shown in FIG. 16, in which reference numerals increased by 100 are used for already known components. In this embodiment, the splashboard 126 extends into the vehicle interior 118 as far as to the dashboard 114. Between the windshield holder 130 and the splashboard 126, there is an intermediate space 170 that accommodates the airbag module 116. The airbag module 116 is not attached to the windshield holder 130 as in the preceding embodiments, but rather to the splashboard 126, namely, on the side facing away from the vehicle interior 118, whereas the air vent 134 is located on the other side of the splashboard 126. The intermediate space 170 is closed off from the engine compartment 174 by a moisture protection wall 172 that is attached to the splashboard 126 and to the windshield holder 130.

This embodiment offers the advantage that the airbag module 116 can be installed from the side of the engine compartment 174. This assembly option is especially advantageous with regard to the normally very bulky, combined driver and passenger modules (FIG. 4).

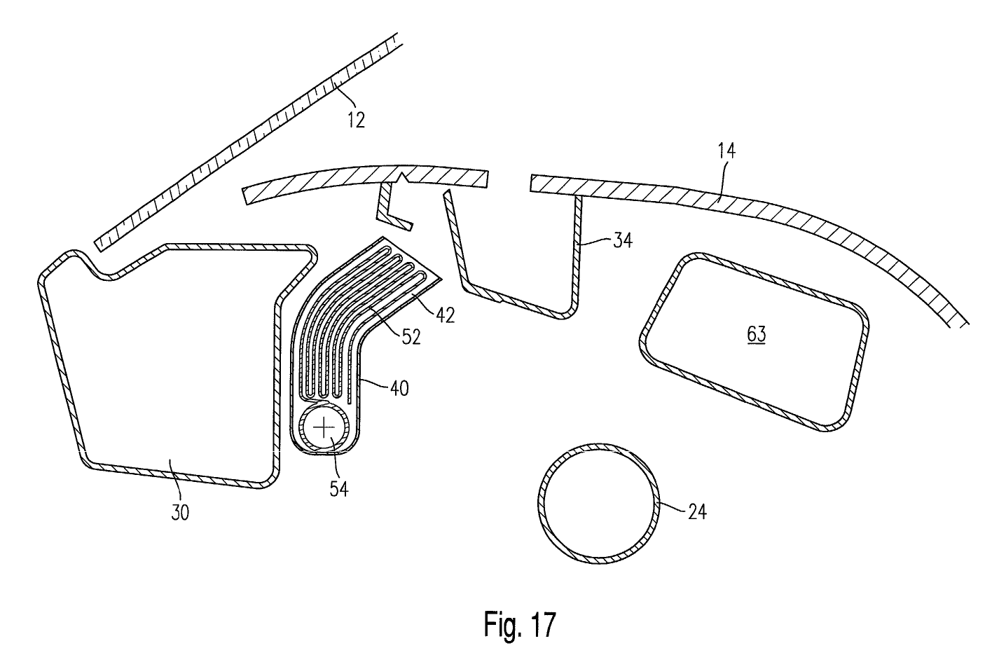

In FIG. 17 there is shown an assembly according to an eighth embodiment of the invention. Unlike the preceding embodiments, the housing is designed to be angled; the ejection channel 42 extends in direction different from that of that part of the housing 40 in which the gas lance 54 is arranged. In this arrangement, the ejection channel 42 is orientated such that it runs parallel to the windshield 12. This results in a smaller load on the windshield, in the event that the gas bag leaves the housing 40. In addition, this results in more space for the windshield holder 30.

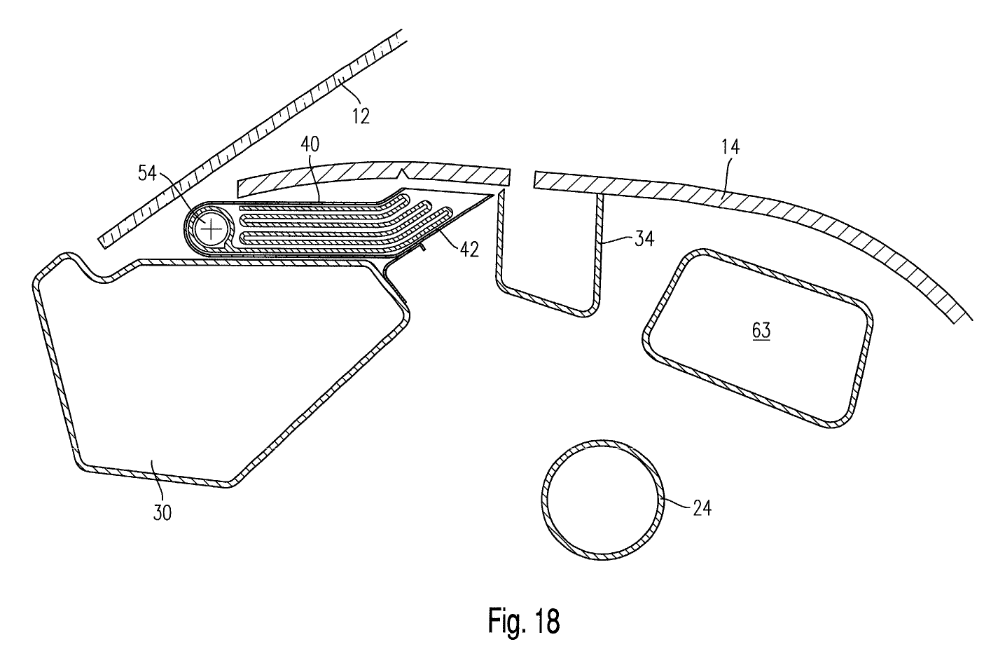

In FIG. 18 there is shown an assembly according to a ninth embodiment.

The housing is configured angled, similar to the eighth embodiment, so that the ejection channel 42 extends parallel to the windshield 12. Unlike the eighth embodiment, the housing 40 is arranged so as to lie horizontally on the windshield holder 30, with this region in which the gas lance 54 is arranged. This is particularly space-saving. Upon activation of the gas bag, it exits through a flap of the dashboard 14, which flap is arranged between the windshield 12 and the air vent 34.

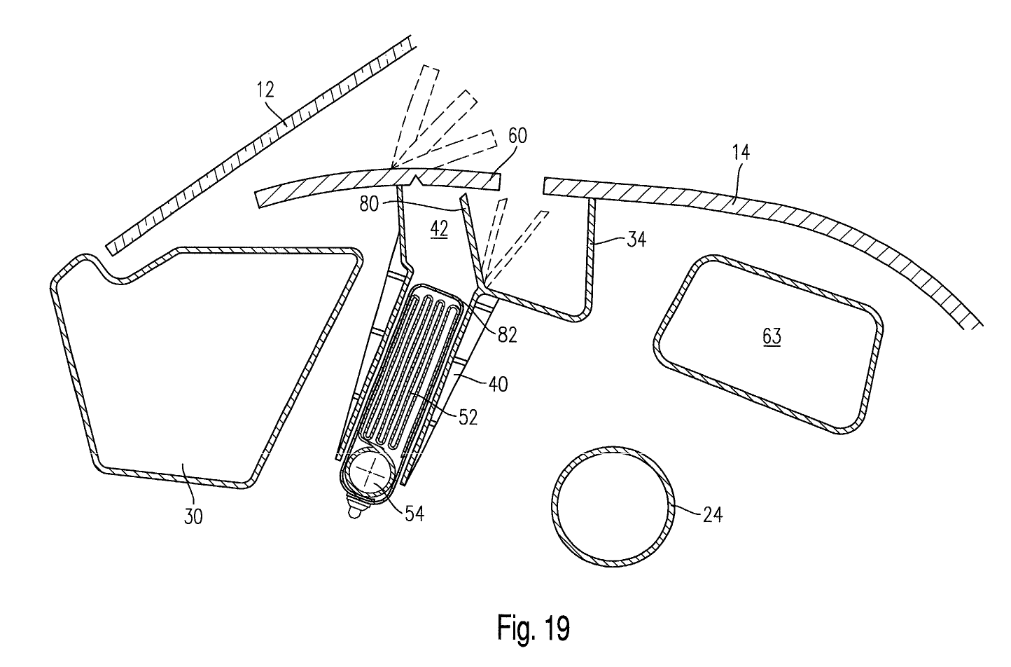

In FIG. 19 there is shown an assembly according to a tenth embodiment. In this embodiment, the housing 40 is configured in one piece with the air vent 34, more precise hanging down from it and in the vicinity of the windshield holder 30. Here, the ejection channel 42 is formed underneath the cover 60, a partition flap 80 being provided for delimiting the air vent 34. Such partition flap is so elastic that it slightly yields upon unfolding of the gas bag, so that the ejection channel expands. It is in this way that the outlet opening of the air vent 34 can also be used for the exit of the gas bag.

The housing 40 of the gas bag can be made in one piece with the air vent 34, with external reinforcement ribs being provided. The gas bag may be encircled in simple manner in the housing 40 by a fabric cover 82.

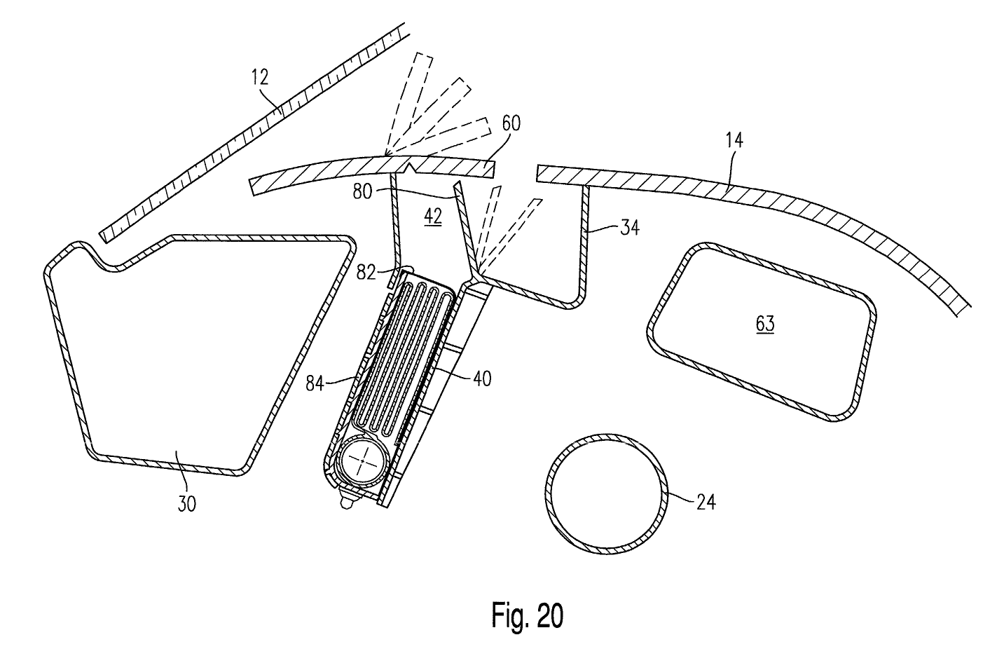

In FIG. 20 there is shown an assembly according to an eleventh embodiment of the invention. Unlike the tenth embodiment, the housing 40 is configured in composite construction. Part of the housing is configured in one piece with the air vent 34, whilst a metal shell 84 made of sheet steel or aluminum is provided on the side facing the windshield holder 30.

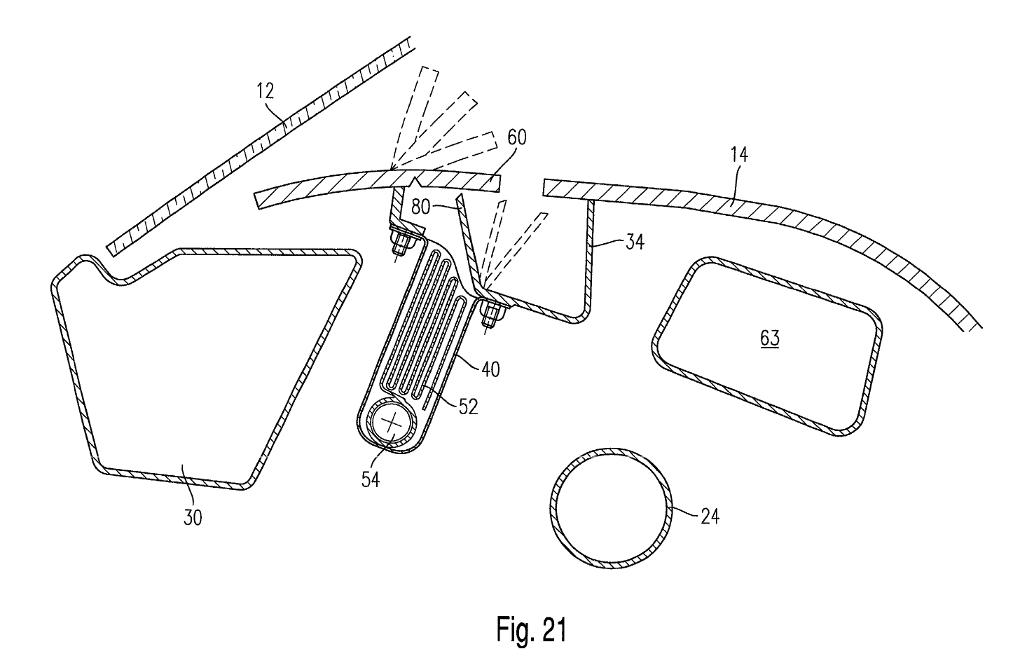

In FIG. 21 there is shown an assembly according to a twelfth embodiment. Unlike the tenth embodiment, the housing 40 is configured here as a component which is separate from the air vent 34, which component may consist of plastic, steel or aluminum and is screwed with the air vent 34.

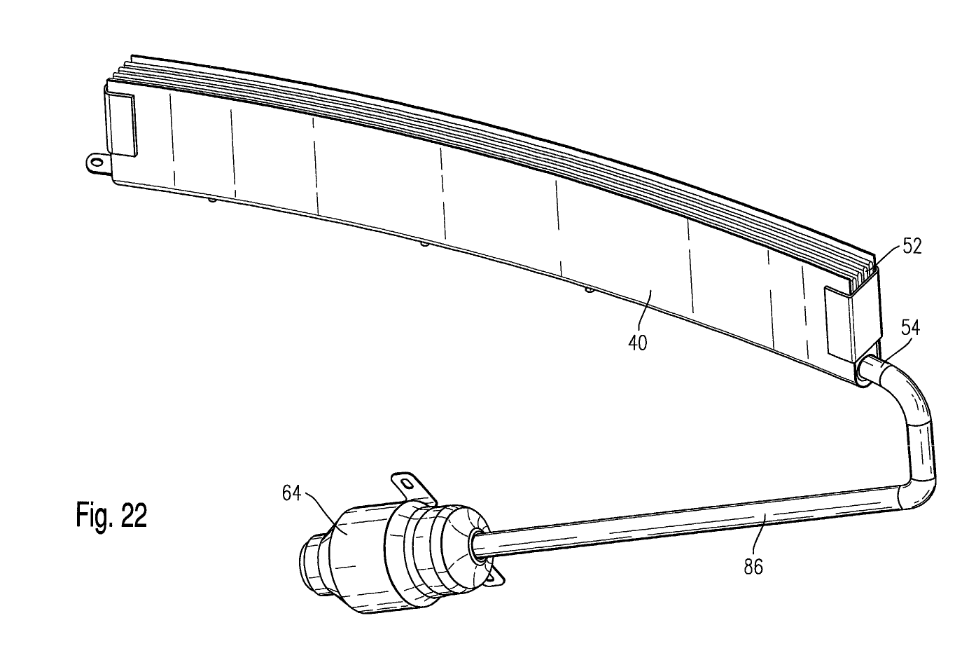

In FIG. 22 there is shown an assembly according to a thirteenth embodiment. The difference to the embodiment shown for instance in FIG. 3 is that there is a transition pipe 86 next to the gas lance 54, which pipe connects the gas lance 54 with the gas generator 64. The transition pipe makes it possible to flexibly arrange the gas generator 64 in the vehicle at a suitable place and with a large distance from the gas bag module.

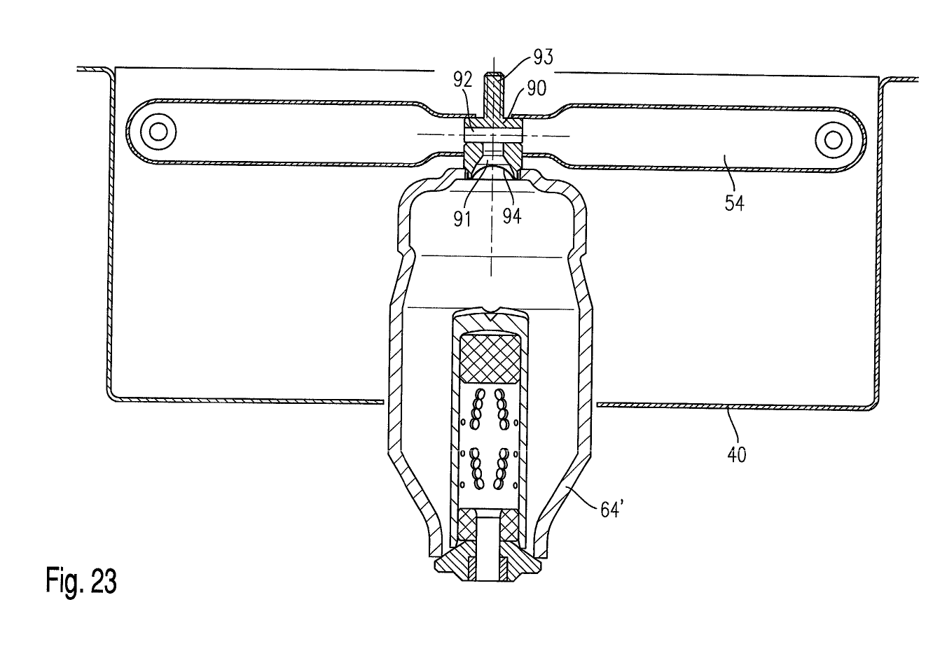

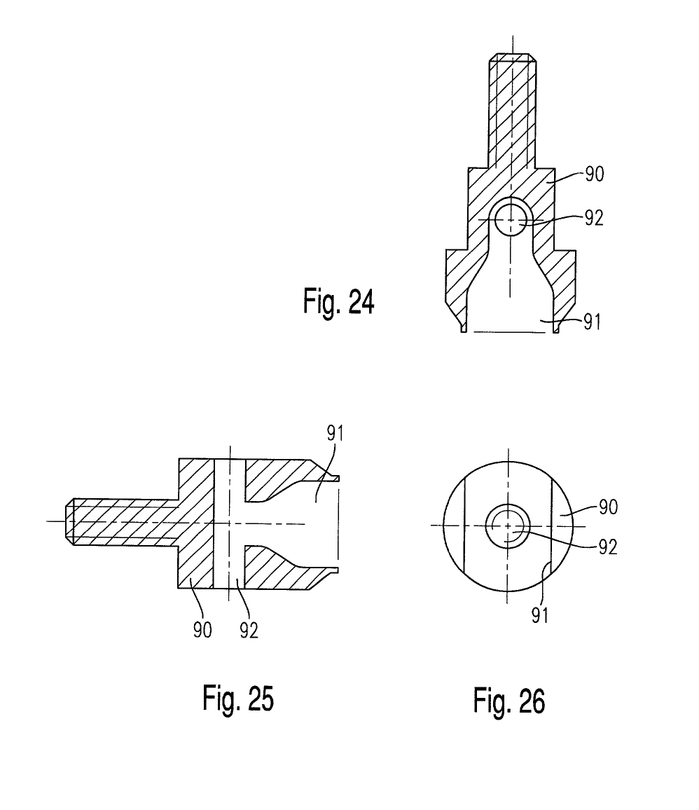

In FIGS. 23 to 26 there is shown one type of mounting for a gas generator 64′ as shown in FIG. 4. The gas generator 64′ is connected with a T-piece 90 that has an inlet opening 91 and an outlet opening 92 extending transversely thereto. A threaded pin 93 is provided on the side facing away from the inlet opening 91, which pin may serve for fastening purposes.

The inlet opening 91 of the T-piece 90 is designed such that it can hold a bursting membrane 94 of the gas generator 64′. It is also in this region where the T-piece is inserted in the gas generator 64′, for example by beading.

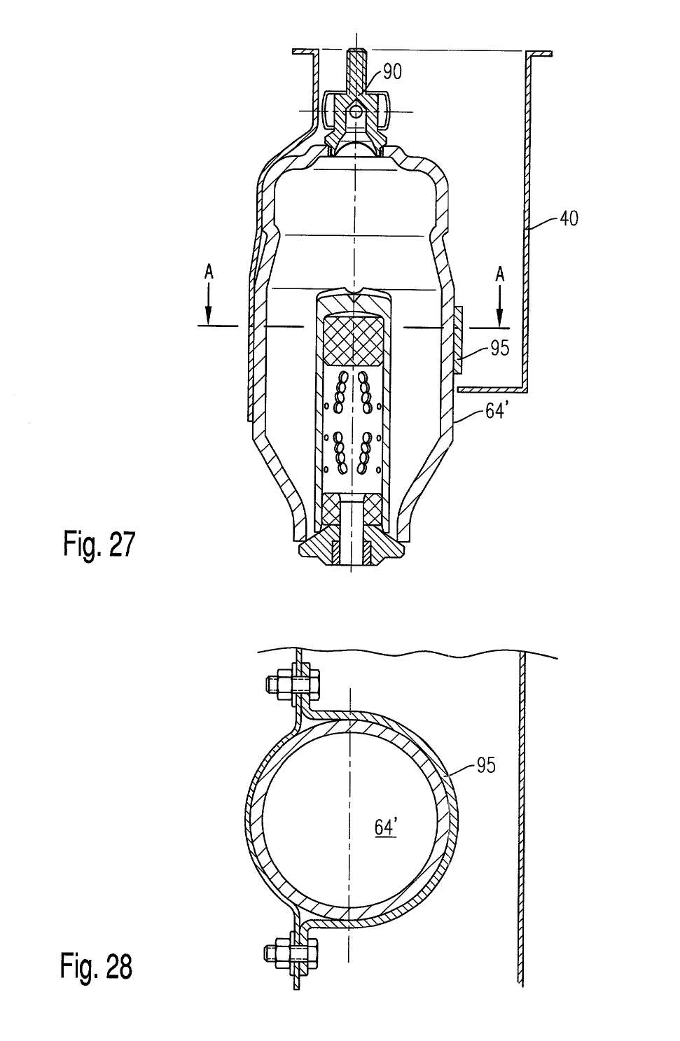

As can be seen in particular in FIGS. 27 and 28, the gas generator 64′ is pushed into the housing 40 from below through an opening and is fastened there by means of a pipe clamp 95. The gas lance 54 extends along the upper edge of the housing (see also FIG. 23). The mounting of the housing is not required to be able to take up particularly high forces, because due to the T-piece the gas generator is attached so as to be neutral with respect to thrust.

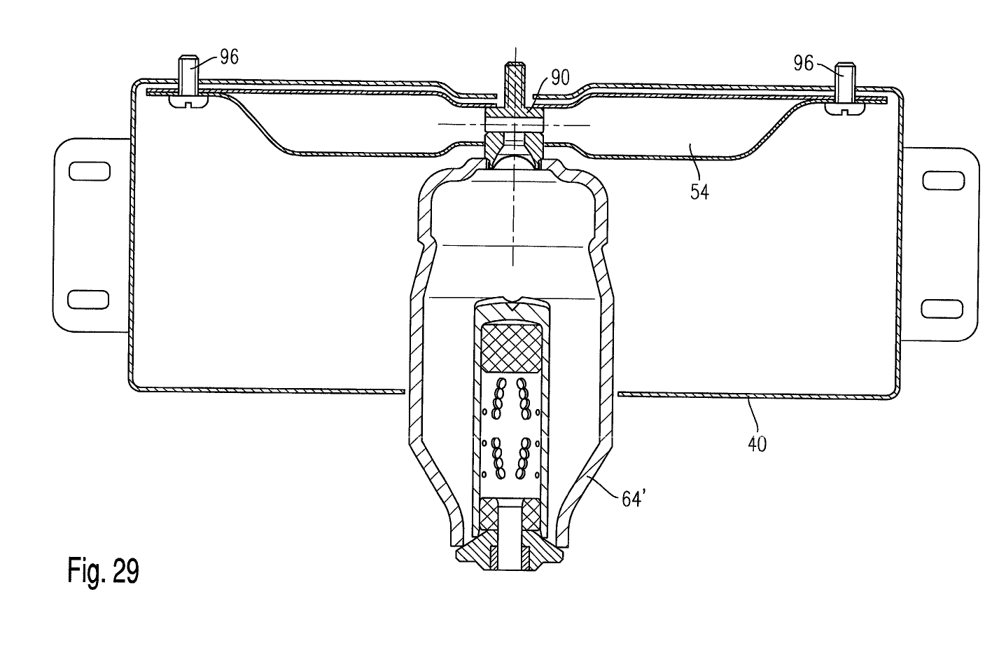

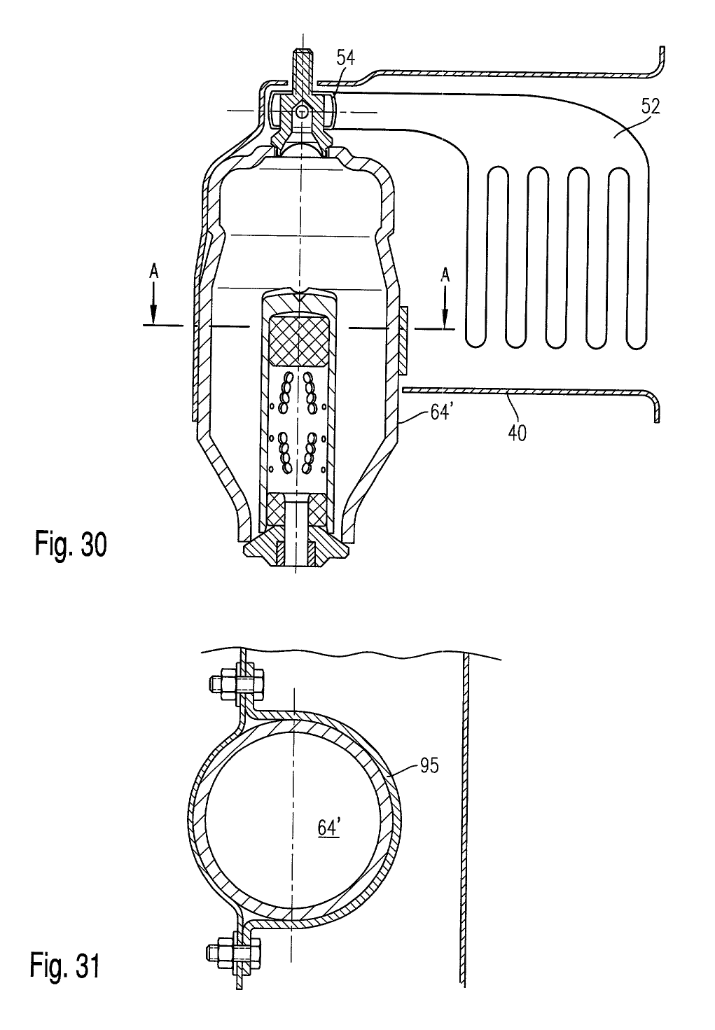

In FIGS. 29 to 31 there is shown a variant in which the gas bag is arranged in front of the gas generator 64 (see in particular FIG. 30). To this end, the gas lance 54 is provided with outlet openings which let the gas flow out parallel to the upper wall of the housing 40 (in FIG. 30 horizontally to the right). The gas lance can be screwed by screws 96 in the same way as the T-piece 90 right through the upper side of the housing 40.

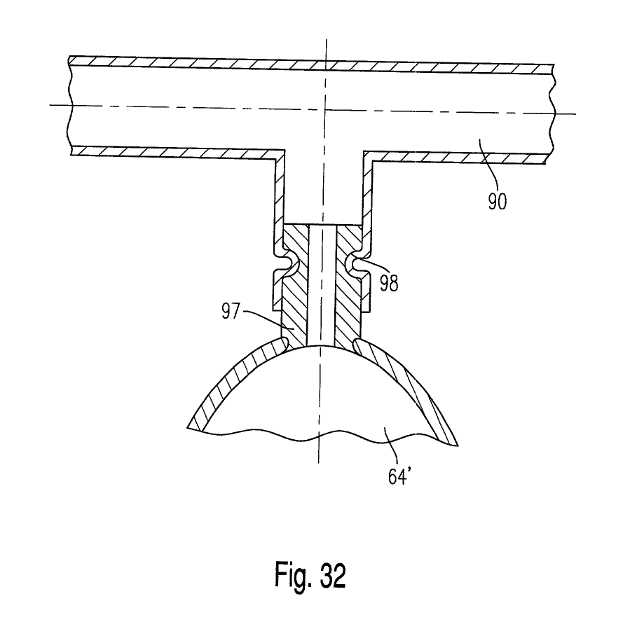

A further variant is shown in FIG. 32. Here, the T-piece 90 is crimped with a membrane holder 97 of the gas generator 64′. To this end, the membrane holder 97 is provided with a groove 98 into which the material of the T-piece 90 is forced.

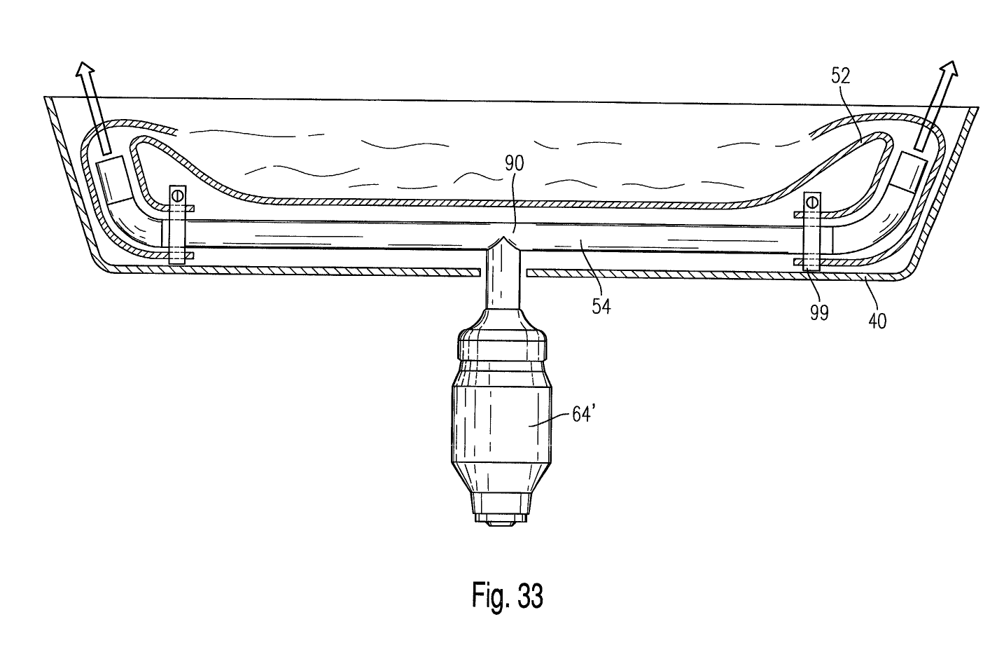

In FIG. 33 there is shown an assembly according to a fourteenth embodiment. In this embodiment, the gas generator 64′ is arranged outside of the housing 40, and the gas lance 54 extends symmetrically at both sides of the T-piece 90 along the lower edge of the housing 40 The gas lance 54 is obliquely bent upwards at both ends. The gas bag 52 is turned over these ends and is fastened by a clamp 99. Upon activation of the gas generator 64′, the gas bag begins to unfold first at the ends of the gas lance 54, namely in the direction indicated by the arrows. The unfolding action then proceeds towards the center.

1. An assembly consisting of a car body, a windshield, a dashboard with an air vent for providing an air flow to said windshield, and an airbag module, said airbag module being arranged between said windshield and said air vent.

2. The assembly according to claim 1, wherein said airbag module comprises an airbag that is folded into an airbag package, and wherein an ejection channel is provided for ejecting said airbag, said ejection channel opening up into an ejection opening through which said airbag can be ejected.

3. The assembly according to claim 2, wherein said airbag module comprises a housing and said ejection channel is limited by a first ejection channel wall that is formed by said housing and by a second ejection channel wall that is formed by said car body.

4. The assembly according to claim 3, wherein said car body comprises a windshield holder for said windshield, said second ejection channel wall being formed by said windshield holder.

5. The assembly according to claim 3, wherein said car body has a splashboard, said second ejection channel wall being formed by said splashboard.

6. The assembly according to claim 2, wherein said airbag module has a gas lance through which a gas can be fed into said airbag.

7. The assembly according to claim 6, wherein said gas lance has a middle as well as ends and is provided with gill-shaped outflow openings.

8. The assembly according to claim 7, wherein said gill-shaped outflow openings are aligned in such a way that said gas flowing out of said gas lance flows towards said ends of said gas lance.

9. The assembly according to claim 7, wherein said gill-shaped outflow openings are aligned in such a way that said gas flowing out of said gas lance flows towards said middle of said gas lance.

10. The assembly according to claim 7, wherein said gill-shaped outflow openings are aligned in such a way that said gas flowing out of said gas lance is swirled up.

11. The assembly according to claim 6, wherein said gas lance is located between said airbag package and said air vent.

12. The assembly according to claim 6, wherein said gas lance is located between said airbag package and said windshield.

13. The assembly according to claim 6, wherein said airbag package comprises first and second partial packages, of which said first partial package is folded in a first manner and is situated closer to said ejection opening, whereas
said second partial package is folded in a second manner and is arranged further away from said ejection opening.

14. The assembly according to claim 13, wherein said first partial package is located between said ejection opening and said gas lance.

15. The assembly according to claim 2, wherein said ejection channel is positioned to be angled with respect to said housing such that it runs parallel to said windshield.

16. The assembly according to claim 1, wherein said airbag module has separate gas generators for a driver side and a passenger side.

17. The assembly according to claim 1, wherein said airbag module has a shared gas generator for a driver side and a passenger side.

18. The assembly according to claim 1, wherein said housing is arranged on said air vent.

19. The assembly according to claim 18, wherein said housing is formed in one piece with said air vent.

20. The assembly according to claim 18, wherein said housing is screwed to said air vent.

21. The assembly according to claim 1, wherein a transition pipe is arranged between said gas lance and said gas generator.

22. The assembly according to claim 6, wherein said gas lance is provided with protrusions in which said gas bag is hung in.

23. The assembly according to claim 1, wherein a T-piece is arranged on said gas generator, said T-piece at the same time serving as a holder for a bursting membrane.

24. The assembly according to claim 1, wherein a T-piece is provided which is crimped with said gas generator.
